(19) United States
(12) Patent Application Publication
(10) Pub. No.: US 2007/0015053 A1
(43) Pub. Date: Jan. 18, 2007

(54) Lithium battery with surfactant coated electrode

(76) Inventor: Robert Scott Morris, Sandwich, MA (US)

Correspondence Address: Stephen J. Gaudet;Perkins Smith & Cohen, One Beacon St., 30th Floor, Boston, MA, 02108, US

(21) Appl. No.: 10/546,416

(22) PCT Filed: Feb. 9, 2004
(86) PCT No.: PCT/US04/03750

§ 371 Date: Aug. 11, 2006

Related U.S. Application Data
(60) Provisional application No. 60/447,500, filed on Feb. 19, 2003.

(51) Int. Cl. H01M 4/62; H01M 4/50; H01M 4/52

(52) U.S. Cl. 429/212; 429/231.8; 429/231.1; 429/223; 429/231.3; 429/224

(57) ABSTRACT

Disclosed herein is a lithium battery wherein a surfactant is combined with one or more electrodes to produce a more efficient and safer battery. This combination appears to preclude the normal development of a solid electrolyte interface (SEI) on the electrodes as occurs with electrodes that are not coated with a surfactant. This electrode surface phenomenon is useful with several different electrolyte systems.

### CROSS REFERENCE TO RELATED APPLICATIONS

This application claims priority to and the benefit of U.S. Provisional Application Ser. No. 60/447,500, filed Feb. 19, 2003.

### FIELD OF THE INVENTION

This invention pertains to a lithium battery. In particular, the present invention relates to an improved lithium battery wherein a surfactant is combined with one or more electrodes in a lithium battery.

### BACKGROUND OF THE INVENTION

Since the commercialization of lithium ion liquid secondary batteries by Sony Co., the lithium ion liquid secondary battery has been used increasingly in portable computers, cellular phones, etc. due to its high energy density. The lithium ion liquid secondary battery comprises an anode comprised of carbonaceous material and a cathode comprised of metal oxide (LiCoO₂, and alike). This battery is prepared by intercalating a porous polyolefin-based separator between the anode and the cathode, then an injection of a non-aqueous electrolyte having a lithium salt of LiPF₆ is typically provided.

When the battery charges, the lithium ions of the cathode are released and then inserted into a carbon layer of the anode. When the battery discharges, the opposite occurs, i.e., the lithium ions of the carbon layer of the anode are released and then inserted into the active material of the cathode.

Practitioners have long sought a safer replacement for the potentially flammable liquid electrolytes commonly employed in Li-ion batteries. Generally, these electrolytes are comprised of cyclic and linear carbonates. The different linear carbonates include dimethyl carbonate (DMC), diethyl carbonate (DEC), ethyl methyl carbonate (EMC), and alike. The different cyclic carbonates include ethylene carbonate (EC), propylene carbonate (PC), vinylene carbonate (VC), butylene carbonate (BC), and alike.

The problem of obtaining good interfacial contact between the electrolyte and the electrodes in a lithium battery has been largely ignored. In a typical Li-ion battery architecture, the largely hydrophobic nature of the carbon anode and the more hydrophilic nature of the metal oxide cathode makes the electrolyte/electrode interface the weak link in achieving a successful battery system. Low interfacial impedance will ensure good ion transport while high impedance ensures system failure.

In addition, the high energy density of a rechargeable lithium-ion battery means an inevitable downside. In the case of Li-ion the drawback manifests itself as a potential safety problem in the event of misuse due to overcharging or physical damage.

Overcharging is particularly insidious, because it is difficult to monitor, should it occur. As little as a few hundred millivolts overcharge can lead to thermal runaway. Scale up of Li-ion technology for use in electric vehicles or for standby power will further exacerbate this problem. Also, future efforts to increase the specific energy of the system will be stymied until this problem can be adequately addressed.

A current need exists for an improved interfacial contact between the electrolyte and the electrodes in a lithium battery thereby lowering the impedance between the electrode and electrolyte.

### BRIEF SUMMARY OF THE INVENTION

The present invention pertains to a lithium battery wherein a surfactant is combined with one or more electrodes to produce a more efficient and safer battery. Further, this combination appears to preclude the normal development of a solid electrolyte interface (SEI) on the electrodes as occurs with electrodes that are not coated with a surfactant. This electrode surface phenomenon is useful with several different electrolyte systems.

One embodiment of the present invention pertains to a lithium battery comprising a surfactant-modified graphite carbon anode, a surfactant-modified lithium metal oxide cathode, a porous separator and an electrolyte. In one aspect, only the carbon anode is modified with a surfactant coating resulting in, e.g., improved lithium ion storage capacity. In another aspect, only the cathode is modified using a suitable surfactant.

In another embodiment, a lithium battery comprises a graphitized carbon that can reversibly store and release lithium as anode material, lithium-containing transition metal oxides that can reversibly store and release lithium as cathode material, a porous separator, and a non-aqueous electrolyte having a lithium salt, an electrolyte compound and a suitable surfactant.

For a better understanding of the present invention, together with other and further objects thereof, reference is made to the accompanying drawings and detailed description and its scope will be pointed out in the appended claims.

### BRIEF DESCRIPTION OF THE SEVERAL VIEWS OF THE DRAWING

FIG. 1 is a graph comparing the impedance of the composite anode versus an untreated anode;

FIG. 2 is a graph comparing the cycling behavior of a battery employing a treated anode versus that with an untreated anode tested using a pure propylene carbonate electrolyte;

FIG. 3 is a graph comparing the cycling behavior of a battery employing a treated anode versus that with an untreated anode tested using an ethylene carbonate, ethylmethyl carbonate electrolyte; and

FIG. 4 is a graph comparing the cycling behavior of a battery employing a treated anode versus that with an untreated anode tested using a proprietary polyether phosphate electrolyte.

### DETAILED DESCRIPTION OF THE INVENTION

The present invention pertains to a lithium battery wherein a surfactant is combined with one or more electrodes to produce a more efficient and safer battery. Further, this combination appears to preclude the normal development of a solid electrolyte interface (SEI) on the electrodes as occurs with electrodes that are not coated with a surfactant. This electrode surface phenomenon is useful with several different electrolyte systems.

At the heart of Li-ion system instability is the SEI that naturally forms at the anode. Development of a stable SEI at the anode surface in Li-ion batteries is key to the proper functioning of a battery. Much effort has been expended over the past decade to understand the formation and composition of the SEI. The key to avoiding graphene exfoliation and to enable Li ion chemistry to function is the formation of a SEI between the sensitive graphite of the anode and the bulk electrolyte solution. A barrier film forms on the graphene anode and is believed to consist of decomposition products resulting from reaction of the lithiated anode with the solvents in the electrolyte. It is a semipermeable film that allows passage of Li⁺ cations while preventing solvent intrusion of the graphene sheets, which would cause exfoliation of this active intercalation medium of the anode.

The SEI is a Janus-like material in that its formation is essential to the proper functioning of the battery, however, it is also a focal point in the potential instability of the system. Recent studies, such as E. Peled, D. Golodnitsky, and G. Ardel, J. Electrochem. Soc., 144, L208 (1997), D. Aurbach and A. Zaban, J. Appl. Electrochem., 348, 155 (1993), Zhang, S.; Ding, M. S.; Xu, K.; Allen, J. and Jow, R. T., Electrochemical and Solid-State Letters, 4, (12), pp. A206-A208 (2001), Andersson, A. M.; Edstrom, K. and Thomas, J. O., J Power Sources, 81-82, 8-12, (1999), the teachings of which are incorporated herein by reference in their entirety, have implicated the SEI as an initiator of instability during the thermal decomposition of a Li-ion system. In fact, Aurbach, in Schalkwijk, W. A. and Scrosati, B. “Advances in Lithium-ion Batteries,” p 67, KIuwer/Plenum, N.Y., (2002), recently stated that the thermal behavior of lithiated carbons in electrolyte solutions proceeds through three steps, “but, the first stage is always a reaction in which the surface films are involved.” Ameliorating the formation of a SEI as a result of a reaction between the electrolyte solvent and the lithiated anode or cathode, would potentially eliminate a major safety problem inherent in Li-ion batteries. The instant invention is a viable approach to resolving this safety problem.

It is well known to those skilled in the art that a reaction between the solvents in liquid electrolytes used in lithium-ion batteries with the lithiated electrodes results in the formation of a SEI on the electrodes. The relative safety of the battery is linked with the stability of this layer. Pre-treating the electrodes in the battery prior to assembly with a stable monolayer of a suitable surfactant that is covalently linked to the electrode will preclude development of the SEI, thereby improving the chemical stability of the interface and improving the safety of the resulting battery.

One embodiment of the present invention pertains to a lithium battery comprising a surfactant-modified anode, a surfactant-modified cathode, a porous separator and an electrolyte. In one aspect, the anode is a carbon anode. In a further aspect, the anode is a graphite carbon anode. In another aspect, the cathode is a lithium metal oxide cathode. In one aspect, only the carbon anode is modified with a surfactant coating resulting in, e.g., improved lithium ion storage capacity. In another aspect, only the cathode is modified using a suitable surfactant.

The carbon anode of the present invention can be comprised of graphite, mesocarbon microbeads, buckyballs, fullerenes, multiwall carbon nanotubes and single wall carbon nanotubes, see, U.S. patent application Ser. No. 10/668,976, filed Sep. 23, 2003, the entire teaching of which is incorporated herein by reference.

The anode of the present invention can comprise a surfactant, such as a nonionic surfactant. In one aspect, the anode can further comprise a reactive end group surfactant selected from the group consisting of vinyl, allyl, acryl propargyl, diene, polyene, isocyanato, lactone, lactam, silane, siloxy, mercaptyl, and epoxy. In another aspect, the anode comprises a cationic surfactant. Such a surfactant can be an ammonium or phosphonium derivative. In still another aspect, the anode can comprise an anionic surfactant. Such an anionic surfactant can be a sulfonate, carboxylate, phosphate or phosphonate. In one particular aspect, the anode of the present invention comprises a fluorinated surfactant. In yet another aspect, the anode can comprise a dimeric (Gemini) surfactant.

The cathode of the present invention can comprise LiNiCoO₂, LiCoO₂, LiNiO₂, LiMnO₂, and alike. In one aspect, the cathode comprises a nonionic surfactant. In one aspect, the cathode comprises an anionic surfactant such as a sulfonate, carboxylate, phosphate or phosphonate. In a particular aspect, the cathode comprises a fluorinated surfactant. In another aspect, the cathode comprises a dimeric (Gemini) surfactant. In another aspect of the present invention, the cathode comprises a reactive end group surfactant selected from the group consisting of vinyl, allyl, acryl, propargyl, diene, polyene, isocyanato, lactone, lactam, silane, siloxy, mercaptyl, and epoxy. In still another aspect, the cathode can comprise a cationic surfactant such as an ammonium or phosphonium derivative.

The battery of the present invention can comprise one or more counterions including, but not limited to, alkaki (Na⁺, Li⁺, K⁺), alkaline earth (Ca⁺², Mg⁺²), transition element (Fe^{+2,+3}, Zn⁺², Ti^{+2,+4}) metal ions, and organic ions, BF₄, Cl, Br, I, ClO₄, sulfonate, sulfonamide, borate, phosphate, phosphonate, PF₆, nitrate, nitrite, triflate, and carboxylate.

In another embodiment, a lithium battery comprises a graphitized carbon that can reversibly store and release lithium as anode material, lithium-containing transition metal oxides that can reversibly store and release lithium as cathode material, a porous separator, and a non-aqueous electrolyte having a lithium salt, an electrolyte compound and a suitable surfactant.

In one aspect of the present invention, a suitable surfactant is reacted with one or more electrodes to form a surfactant-electrode composite. Alternatively, the surfactant is chemically synthesized in situ at the electrode surface. As a result of treating the electrodes, the battery exhibits a higher capacity than a corresponding battery with untreated electrodes tested under identical circumstances. In addition, the interfacial impedance of the treated electrodes is found to be significantly lower than that of untreated electrodes following exposure of these to standard liquid carbonate electrodes. This effect appears to be independent of the electrolyte employed since the aforementioned treated anodes perform better in a standard liquid electrolyte and a special low molecular weight polyether phosphate electrolyte.

The present invention involves treating an anode and/or cathode of a Li-ion battery with a surface coating of a suitable surfactant (including polymerizable surfactants) that has been dissolved in a solvent for delivery. Following preparation of approximately 10-25 w/o surfactant solution, about 5-20 mg/cm² of this solution is applied to the surface of the electrode to be treated in a drop-wise fashion. The treated electrode is then air dried at around 75° C. for about 15 minutes to evaporate the solvent The solvent evaporation leaves the surfactant on the surface of the electrode. The combination is then heated at around 100° C. for about 60 minutes to link the surfactant to the carbon surface thereby preventing diffusion of the surfactant away from the carbon electrode. Photochemical or electron beam irridiation can also be used to form the linkage. This linkage includes either covalent, ionic or another chemical linkage. In a similar manner, the same approach can be taken to cover the cathode of the battery with a similar, but chemically distinct surfactant thereby protecting that surface by forming a surfactant-electrode composite. Collectively, the surfactants are distinct in that they will interface with and compatabilize the anode or cathode surfaces with the adjacent electrolyte. As such, they are distinct chemical moieties from the electrode and electrolyte compositions. The same surfactants may prove useful on both electrode types.

In one aspect, at least a full monomolecular coating layer is required on the electrode surface to obtain suitable long term battery performance. Thicker than monomolecular layer coatings are desired in many applications.

Alternatively, the surfactant could be delivered without a solvent and form a coating via synthesis at the active surface. It is well known that vinyl or acryl long chain compounds are readily electropolymerized by means of the formation of radicals and/or ions formed by the passage of a current. By way of example, surface adsorbed dodecyl acrylamide, in the presence of tetrabutylammonium perchlorate, results in polymerization by perchlorate radical at the anode. Similarly, anionic polymerization at the cathode occurs by direct transfer of electrons to the monomer.

Suitable solvents include, but are not limited to, methylene chloride, tetrahydrofuran, chloroform, toluene, acetonitrile, alkyl carbonates, acetone, methanol and the like.

The use of surfactants as a means for treating Li-ion battery electrode surfaces is neither routine in the art nor is it intuitive to those skilled in the art. There is a paucity of references in the literature reporting such treatment and/or battery.

Surfactant is an abbreviation for surface-active agent and is a substance or agent, as in a detergent, that is active at a surface. This surface activity is exemplified by the tendency of surfactants to absorb at interfaces and surfaces. The term interface denotes a boundary between any two immiscible phases while the term surface indicates that one of the phases is a gas, usually air. The driving force for a surfactant to absorb at an interface is to lower the free energy of that phase boundary. Interfaces include solid-gas (surface), solid-liquid, solid-solid, liquid-gas (surface) and liquid-liquid. Surfactants are amphiphilic indicating that surfactants are comprised of at least two parts, the lyophilic part, which is soluble in a specific fluid, and the lyophobic part, which is insoluble. When the fluid is water, the lyophilic and lyophobic segments are referred to as hydrophilic and hydophobic, respectively.

Suitable surfactants or detergents include compounds identified as non-ion surfactants, organosilicone surfactants, Gemini surfactants, and alike.

One family of surfactants are the non-ionic surfactant class including the Brij® and Igepal® families of compounds (a trademark of ICI Americas, Inc) and have been found to be useful as have the Triton® family (Dow Chemical), Silwet® (Union Carbide) and the Dowanol™ family (Dow Chemical).

Non-ionic surfactants consist of alkylene glycol alkyl/aryl ethers, block copolymers of polyethylene, ethylene oligomers, or other hydrocarbon chains with polyoxyalkylene chains or polyglycols such as ethylene glycol, propylene glycol, or any other alkylene/arylene diols, and alike. Non-ionic surfactants include the following commercial products: Brij® compounds (a trademark of ICI Americas, Inc.) examples of which comprise Brij® 30, Brij® 35, Brij® 52, Brij® 56, Brij® 58, Brij® 72, Brij® 76, Brij® 78, Brij® 92, Brij® 97, Brij® 98, Brij® 700, etc., and Triton® compounds (a trademark of Union Carbide Chemical & Plastics Technology Corp., a subsidiary of The Dow Chemical Company) examples of which comprise Triton® X-100; Triton® X-100, reduced; Triton® X-114; Triton® X-114, reduced; and alike.

Organosilicone surfactants consist of polyalkyleneoxide-modified siloxanes. Organosilicone surfactants include the following commercial products: Silwet® trisiloxane surfactants (Union Carbide) examples of which comprise Silwet® 408, Silwet® 560, Silwet® 806, Silwet® L-77®, Silwet® L-7001, Silwet® L-7087, Silwet® L-7200, Silwet® L-7210, Silwet® L-7220, Silwet® L-7280, Silwet® L-7500, Silwet® L-7510, Silwet® L-7600, Silwet® L-7602, Silwet® L-7604, Silwet® L-7605, Silwet® L-7607, Silwet® L-7608, Silwet® L-7622, and alike.

Other compounds include polyoxyarylene compounds. Polyoxyarylene products include Dowanol™ compounds (a trademark of Dow Chemical Corporation) examples of which comprise Dowanol™ DB, Dowanol™ DM, Dowanol™ DPM, Dowanol™ DPMA, Dowanol™ DPnB, Dowanol™ DPnP, Dowanol™ EB, Dowanol™ EPh, Dowanol™ PM, Dowanol™ PnB, Dowanol™ PnP, Dowanol™ PPh, Dowanol™ TPM, Dowanol™ TPnB, and alike.

A second family of suitable surfactants are those commonly referred to as anionic surfactants. This broad class includes sulfonates (e.g., dodecyl sulfonate), carboxylates, phosphates and phosphonates. Within this broad class of compounds many different counterions are possible including the alkaki (Na⁺, Li⁺, K⁺) and alkaline earth (Ca⁺², Mg⁺²) and transition element (Fe^{+2,+3}, Zn⁺², Ti^{+2,+4}) metal ions, as well as organic ions.

A third family of suitable surfactants are those commonly referred to as cationic surfactants. These include ammonium or phosphonium derivatives, e.g., cetyl trimethyl ammonium bromide or chloride are commonly used. (See, Jonsson, B., Lindman, B. Holmberg, K., Kronberg, B., Surfactants and Polymers in Aqueous Solution, John Wiley, NY 1998, the entire teachings of which are incorporated herein by reference.)

A fourth type of suitable surfactant that can be used in the present invention include those with reactive groups that can be polymerized. (Summers, M., Eastoe, J., “Applications of Polymerizable Surfactants”in Adv. Colloid and Interface Sci. 100 137 2003, the entire teachings of which are incorporated herein by reference.) One example is PolyFox TB (Omnova Corp, Fairlawn, Ohio), PolyFox TB has acrylate terminations making it useful as a co-monomer or crosslinker in thermally or UV/EB activated free radical acrylic systems. This family of surfactants can also be covalently linked to the electrode surface. Besides radical polymerization, cationic and ionic polymerization mechanisms are possible.

A fifth type of suitable surfactant is based upon silicone chemistry. Typically these surfactants have a hydrophobic polydimethylsiloxane backbone to which water soluble substituents, both charged and uncharged, are functionalized. Polyethylene and polypropylene glycols are the most common substituents. By way of example dimethylsiloxane-ethylene (or propylene) oxide block copolymers of MW=600-30,000 (Gelest, Inc.) are representative materials.

A sixth type of suitable surfactant is that commonly referred to as dimeric surfactants, commonly referred to as Geminis. (See, Zana, R., “Dimeric Surfactants” J. Colloid and Interface Sci. 248 203 (2002), the entire teachings of which are incorporated herein by reference.) These surfactants are typified by having two ampiphilic moieties whose head groups are connected by a linker group, the latter most commonly alkyl in nature. By way of example, one such surfactant is 12-2-12 (dimethylene-1,2-bis(docdecyldimethyl-ammonium bromide)).

A seventh class of suitable surfactants are those that are fluorinated, e.g., Zonyl® TM, one of a class of reactive fluorinated materials marketed by DuPont.

One skilled in the art will appreciate that within the above described surfactant types there are many chemical modifications that can be practiced in the art and remain within the scope of the present invention. For example, amine oxide sulfonyl succinates, alkanol amides, a olefin-based, polysaccharide-based, betaines, phosphate esters, and alkyne moieties occur commonly in commercial surfactant applications.

The battery of the present invention comprises a lithium salt which can be in the form of LiClO₄, LiCF₃SO₃, LiPF₆, LiBF₄, LiASF₆, LiN(CF₃[CF₂]ₙSO₂)₂ wherein n=1 or 4. One skilled in the art will appreciate that other lithium salts can be used in the present invention without departing from the scope and spirit of the invention.

The electrolyte of the present invention can comprise one more of the following, ethylene carbonate, propylene carbonate, ethyl methylcarbonate, vinylene carbonate, sulfolane, dimethyl carbonate, diethyl carbonate, trimethyl phosphate, dimethyl methyl phosphonate and 1,4-dioxane. In one aspect, the electrolyte comprises one or more of the following polyethylene glycol or oxide, polypropylene glycol or oxide, and polyphosphates, polyphosphates, and polyphosphonates.

### EXAMPLES

### Example 1

Mesocarbon microbeads (MCMB) anodes and LiNiCoO₂ cathodes, courtesy of Yardney Technical Products, Pawcatuk, Conn., were punched into disks with an area of 1.0 cm² and dried at 60° C. in vacuo for 24 hours. MCMB anodes were modified by treating with 2 drops of a 10 wt. % solution of Brij52®, a polyethylene-co-polyethylene oxide surfactant, in tetrahydrofuran (THF from Aldrich) and then heating at 120° C. for 5 minutes. Complex impedance spectra were obtained over a frequency range of 0.01 Hz to 100 kHz using a Voltalab Radiometer model PGZ 301 electrochemical test apparatus. The MCMB anodes were charged at 0.5 mA/cm² for 3 hr and discharged at 50 mA/cm² for 5 min in Li half-cells. The MCMB anodes were then analyzed in symmetrical cells following the procedure of Zhang et al. (Zhang, S. S., et al., J. Power Sources (2003) 115, 137ff, the entire teaching of which is incorporated herein by reference) which eliminates the complication of asymmetric cells. These tests employed 1.0 M lithium bis(trifluoromethylsulfonyl)imide (LiIm) (3M) in a 1:1:3 wt. % propylene carbonate (PC, Aldrich)/ethylene carbonate (EC, Aldrich)/ethyl methyl carbonate (EMC, EM Science) solvent mixture.

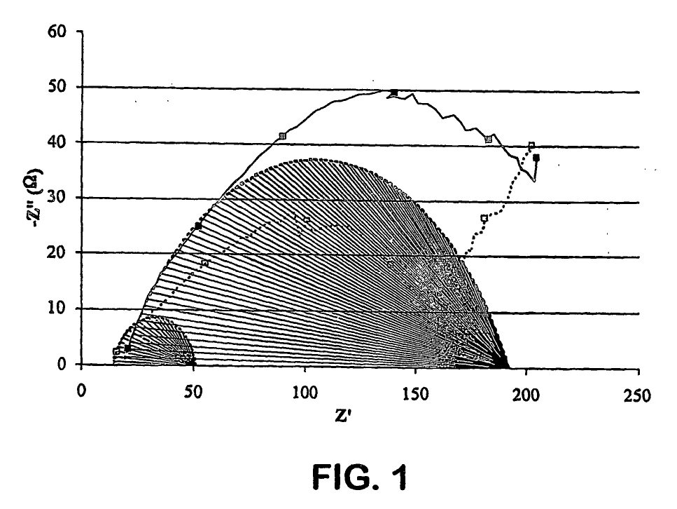

FIG. 1 shows a comparison of MCMB symmetrical cells with and without a surfactant treatment. The interfacial resistance for the surfactant-treated anode is much lower than the untreated anode (R₂=37 versus 174 ohm/cm² respectively). This suggests that the surfactant inhibits the formation of an SEI layer. In addition, the electrolyte resistance is also lower with the surfactant treatment presumably because of the electrolyte does not react with the catalytic anode surface. Similar results were obtained with 1 M LiIm in our proprietary phosphorus polyether electrolyte.

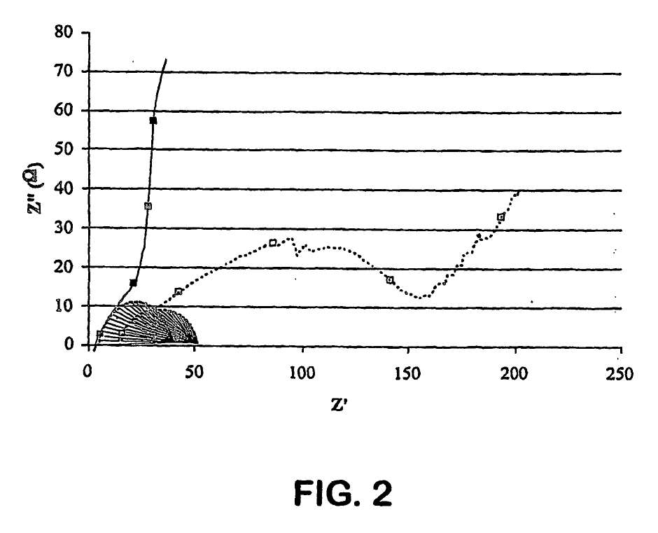

FIG. 2 is a comparison between the impedance for an unlithiated cell versus a lithiated cell that was treated with surfactant. The plot shows that the resistance caused by SEI formation is essentially zero in the lithiated cell with a treated anode (R₂=38 for the unlithiated/untreated anode versus 37 ohm/cm² for the lithiated/surfactant-treated anode).

Galvanostatic cycling experiments were conducted in a full cell consisting of an MCMB anode and a LiNiCoO₂ cathode with 1.0 M LiIm in pure PC or in our proprietary phosphorus polyether (PPE). The cells were charged at 100 microA/cm² for 3 hr and discharged at 50 microA/cm² for 30 min. All tests were conducted in a 1.0 cm² cylindrical test cell with two pieces of a 20 micron-thick porous separator, composed of either glass (Hovosorb) or polypropylene (PP, Celgard 2325), in a glove box under an argon atmosphere.

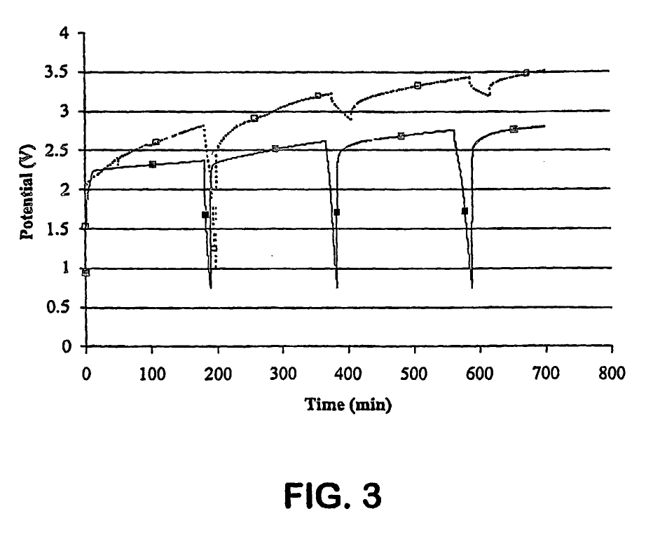

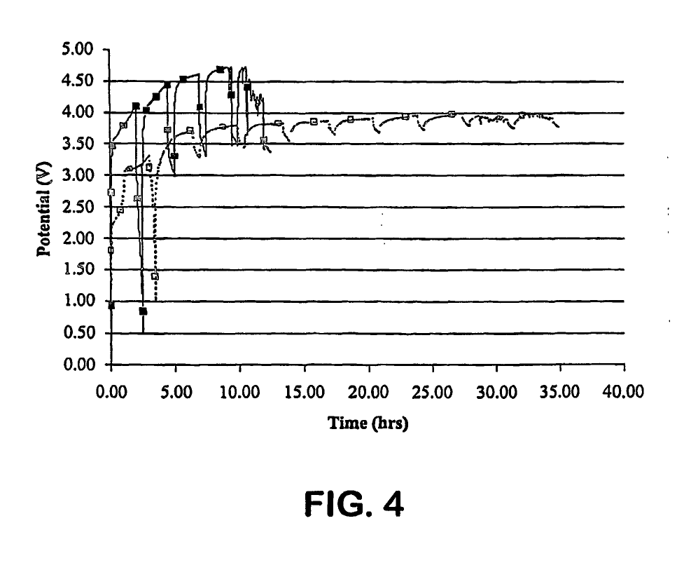

The cycling tests clearly show an improved performance for the surfactant-treated anodes (FIGS. 3 and 4). FIG. 3 shows the initial charging of the cell with a liquid electrolyte consisting of 1.0 M LiIm in pure PC. The charging was enhanced dramatically by the surfactant treatment. In the second discharge cycle, the cell with the surfactant treatment held a charge while the untreated anode showed no retention of charge even after three full cycles. FIG. 4 shows the cycling with our proprietary phosphorus polyether electrolyte where the addition of surfactant to the MCMB surface results in improved cycling without the polarization apparent without surfactant-treatment. While both cells show charge retention in the second discharge cycle, the charge retention for the cell with surfactant-treated anode displays a much lower initial voltage drop (0.3 V versus over 1 V). In these preliminary experiments, voltage losses during charging may indicate dendrite formation. For the cell with the untreated anode, these voltage losses occur within 10 hours versus after over 29 hours for the cell where the anode was treated with surfactant.

### Example 2

MCMB anodes and LiNiCoO₂ cathodes coated by polymerizing Zonyl® TM fluoroacrylate monomer (DuPont) catalyzed by 1% of an azide or peroxide initiator at 60-100° C. Complex impedance spectra were obtained over a frequency range of 0.01 Hz to 100 kHz using a Voltalab Radiometer model PGZ 301 electrochemical test apparatus. The MCMB anodes were and analyzed as described in example 1. These tests also employed 1.0 M lithium bis(trifluoromethylsulfonyl)imide (LiIm) (3M) in a 1:1:3 wt. % propylene carbonate (PC, Aldrich)/ethylene carbonate (EC, Aldrich)/ethyl methyl carbonate (EMC, EM Science) solvent mixture, however, other lithium salts, such as lithium triflate and lithium perchlorate, are similarly effective.

### Example 3

MCMB anodes and LiNiCoO₂ cathodes were treated by solvent deposition of an anionic surfactant, and then characterized as described in Examples 1 and 2. More specifically, the electrode substrate is exposed to a 1-5% solution of sodium dodecyl sulfate in chloroform or methylene chloride, followed by thermal evaporation of the solvent.

### Example 4

MCMB anodes and LiNiCoO₂ cathodes were treated by solvent deposition of a cationic surfactant, and then characterized as described in Examples 1 and 2. More specifically, the electrode substrate is exposed to a 1-5% solution of cetyltrimethyl-ammomium bromide or chloride in chloroform or methylene chloride, followed by thermal evaporation of the solvent.

Although the invention has been described with respect to various embodiments, it should be realized this invention is also capable of a wide variety of further and other embodiments within the spirit and scope of the appended claims

What is claimed is:

1. A lithium battery, comprising at least one surfactant-modified electrode, a porous separator, and an electrolyte.

2. The battery of claim 1, wherein said surfactant-modified electrode is selected from the group consisting of an anode and a cathode.

3. The battery of claim 2, wherein said surfactant-modified electrode is an anode.

4. The battery of claim 3, wherein said anode is a carbon anode.

5. The battery of claim 4, wherein said carbon anode is selected from a group consisting of graphite, mesocarbon microbeads, buckyballs, fullerenes, multiwall carbon nanotubes and single wall carbon nanotubes.

6. The battery of claim 4, wherein said anode comprises a nonionic surfactant.

7. The battery of claim 4, wherein said anode comprises a reactive end group surfactant selected from the group consisting of vinyl, allyl, acryl, propargyl, diene, polyene, isocyanato, lactone, lactam, silane, siloxy, mercaptyl, and epoxy.

8. The battery of claim 4, wherein said anode comprises a cationic surfactant selected form the group consisting of ammonium and phosphonium derivatives.

9. The battery of claim 4, wherein said anode comprises an anionic surfactant selected form the group consisting of sulfonates, carboxylates, phosphates and phosphonates.

10. The battery of claim 4, wherein said anode comprises a fluorinated surfactant.

11. The battery of claim 4, wherein said anode comprises a dimeric (Gemini) surfactant.

12. The battery of claim 2, wherein said surfactant-modified electrode is a cathode.

13. The battery of claim 12, wherein said cathode is a lithium metal oxide cathode.

14. The battery of claim 13, wherein said cathode is selected from a group consisting of LiNiCoO₂, LiCoO₂, LiNiO₂, LiMnO₂, and alike.

15. The battery of claim 14, wherein said cathode comprises an anionic surfactant selected form the group consisting of sulfonates, carboxylates, phosphates and phosphonates.

16. The battery of claim 14, wherein said cathode comprises a fluorinated surfactant.

17. The battery of claim 14, wherein said cathode comprises a dimeric (Gemini) surfactant.

18. The battery of claim 13, wherein said cathode comprises a reactive end group surfactant selected from the group consisting of vinyl, allyl, acryl, propargyl, diene, polyene, isocyanato, lactone, lactam, silane, siloxy, mercaptyl, and epoxy.

19. The battery of claim 13, wherein said cathode comprises a cationic surfactant selected form the group consisting of ammonium or phosphonium derivatives.

20. The battery of claim 19 further comprising one or more counterions selected from the group consisting of BF₄, Ca, Br, I, ClO₄, sulfonate, sulfonamide, borate, phosphate, phosphonate, PF₆, triflate, nitrate, nitrite, and carboxylate.

21. The battery of claim 13, wherein said cathode comprises a nonionic surfactant.

22. The battery of claim 15 further comprising one or more counterions selected from the group consisting of alkaki (Na⁺, Li⁺, K⁺), alkaline earth (Ca⁺², Mg⁺²), transition element (Fe^{+2,+3}, Zn⁺², Ti^{+2,+4}) metal ions, and organic ions.

23. The battery of claim 8 further comprising a counterion, wherein said counterion is selected from the group consisting of BF₄, Cl, Br, I, ClO₄, sulfonate, sulfonamide, borate, phosphate, phosphonate, PF₆, nitrate, nitrite, triflate, and carboxylate.

24. The battery of claim 9 further comprising one or more counterions selected from the group consisting of alkaki (Na⁺, Li⁺, K⁺), alkaline earth (Ca⁺², Mg⁺²), transition element (Fe^{+2,+3}, Zn⁺², Ti^{+2,+4}) metal ions, and organic ions.

25. The battery of claim 1, wherein said surfactant is selected from the group consisting of non-ion surfactants, organosilicone surfactants, Gemini surfactants, and alike.

26. The battery of claim 25, wherein said surfactant is selected from the group consisting of alkylene glycol alkyl/aryl ethers, block copolymers of polyethylene, ethylene oligomers, hydrocarbon chains with polyoxyalkylene chains, polyglycols such as ethylene glycol, propylene glycol, other alkylene/arylene diols, Brij® compounds such as Brij® 30, Brij® 35, Brij® 52, Brij® 56, Brij® 58, Brij® 72, Brij® 76, Brij® 78, Brij® 92, Brij® 97, Brij® 98, Brij® 700, Triton® compounds such as Triton® X-100, Triton® X-100, Triton® X-114; Triton® X-114, polyalkyleneoxide-modified siloxanes, Silwet® such as Silwet® 408, Silwet® 560, Silwet® 806, Silwet® L-77®, Silwet® L-7001, Silwet® L-7087, Silwet® L-7200, Silwet® L-7210, Silwet® L-7220, Silwet® L-7280, Silwet® L-7500, Silwet® L-7510, Silwet® L-7600, Silwet® L-7602, Silwet® L-7604, Silwet® L-7605, Silwet® L-7607, Silwet® L-7608, Silwet® L-7622, polyoxyarylene compounds such as Dowanol™ compounds such as Dowanol™ DB, Dowanol™ DM, Dowanol™ DPM, Dowanol™ DPMA, Dowanol™ DPnB, Dowanol™ DPnP, Dowanol™ EB, Dowanol™ EPh, Dowanol™ PM, Dowanol™ PnB, Dowanol™ PnP, Dowanol™ PPh, Dowanol™ TPM, and Dowanol™ TPnB.

27. The battery of claim 1 further comprising a lithium salt, wherein said salt is selected from the group consisting of LiClO₄, LiCF₃SO₃, LiPF₆, LiBF₄, LiASF₆, LiN(CF₃[CF₂]ₙSO₂)₂, wherein n=1 or 4.

28. The battery of claim 1, wherein said electrolyte comprises one or more agents selected from the group consisting of ethylene carbonate, propylene carbonate, ethyl methylcarbonate, vinylene carbonate, sulfolane, dimethyl carbonate, diethyl carbonate, trimethyl phosphate, dimethyl methyl phosphonate and 1,4-dioxane.

29. The battery of claim 1, wherein said electrolyte comprises one or more agents selected from the group consisting of polyethylene glycol or oxide, polypropylene glycol or oxide, and polyphosphates, polyphosphates, and polyphosphonates.
